(19) United States
(12) Patent Application Publication
(10) Pub. No.: US 2019/0376779 A1
(43) Pub. Date: Dec. 12, 2019

(54) MAGNETIC POSITION SENSOR

(71) Applicant: HAMLIN ELECTRONICS (SUZHOU) CO. LTD., Suzhou, Jiangsu (CN)

(72) Inventors: Rex LIU, Jiangsu (CN); Bens XIE, Jiangsu (CN)

(73) Assignee: HAMLIN ELECTRONICS (SUZHOU) CO. LTD., Suzhou, Jiangsu (CN)

(21) Appl. No.: 16/472,328

(22) PCT Filed: Dec. 22, 2016
(86) PCT No.: PCT/CN2016/111469

§ 371 Date: Jun. 21, 2019

(51) Int. Cl. G01B 7/00; B60N 2/90; B60N 2/06

(52) U.S. Cl. CPC G01B 7/003; B60R 21/01554; B60N 2/06; B60N 2/90

(57) ABSTRACT

A disclosed apparatus includes a sensor housing. First and second magnets may be disposed in the sensor housing. A magnetic field sensor may be disposed between the first and second magnets. A sensor element may be positioned in a vicinity of the sensor housing, the sensor element to cause a magnetic field between the first and second magnets to substantially bypass the magnetic field sensor. The sensor housing may be coupled to a movable rail. The sensor element may be coupled to a fixed rail. The movable rail may be engaged with the fixed rail and movable relative to the fixed rail.

### BACKGROUND

### Field

The present disclosure generally relates to magnetic position sensors. In particular, the present disclosure relates to magnetic position sensors used to determine a position of vehicular seats.

### Description of Related Art

Driver and passenger vehicular seats are generally movable. For example, the vehicular seats may be attached to a track arrangement. The track arrangement may include a fixed rail that is coupled to a floor of an associated vehicle. Furthermore, the track arrangement may include a movable rail that is coupled to a vehicular seat. The movable rail that is coupled to the vehicular seat may be positioned to engage the fixed rail that is coupled to the floor of the associated vehicle. Fore and aft positioning of the vehicular seat may be achieved by movement of the movable rail along the fixed rail. Movement of the vehicular seat may be achieved using one or more electric motors, or by way of a mechanical latch and release mechanism.

Airbags are deployed in most vehicles. For example, airbags may be deployed in vehicles to protect occupants from severe injury in the event of a vehicular accident. In some applications, one or more position sensors may be associated with a movable vehicular seat to provide multiple position outputs pertaining to the movable vehicular seat for the purpose of ascertaining occupant position within a vehicle. The multiple position outputs provided by the one or more position sensors may be used to control the deployment of the airbags.

Conventional position sensors associated with movable vehicular seats are generally complicated and costly to manufacture. For example, some conventional position sensors use a plurality of shaped magnets that that add to the cost of manufacture. Therefore, there exists a need to provide position sensors, which may be associated with movable vehicular seats, that have a simple design and are cost-efficient to manufacture.

Other problems with conventional position sensors will become apparent in view of the disclosure below.

### SUMMARY

This Summary is provided to introduce a selection of concepts in a simplified form further described below in the Detailed Description. This Summary is not intended to identify key or essential features of the claimed subject matter, nor is this Summary intended as an aid in determining the scope of the claimed subject matter.

According to one implementation, an apparatus includes a sensor housing. First and second magnets may be disposed in the sensor housing. A magnetic field sensor may be disposed between the first and second magnets. A sensor element may be positioned in a vicinity of the sensor housing, the sensor element to cause a magnetic field between the first and second magnets to substantially bypass the magnetic field sensor.

According to another implementation, an apparatus may include a fixed rail. A movable rail may be engaged to the fixed rail, the movable rail movable relative to the fixed rail. A sensor housing may include a plurality of magnets and a magnetic field sensor, the sensor housing coupled to the fixed rail or the movable rail. A switching plate may be coupled to the fixed rail or movable rail that does not include the sensor housing, the switching plate to cause to cause a magnetic field between the first and second magnets to substantially bypass the magnetic field sensor.

### BRIEF DESCRIPTION OF THE DRAWINGS

FIG. 1 illustrates a positon sensor arrangement, according to an exemplary embodiment of this disclosure;

FIG. 2 illustrates magnetic field lines related to magnets of the position sensor arrangement, according to an exemplary embodiment of this disclosure;

FIG. 3 provides another illustration of magnetic field lines related to the magnets of the position sensor arrangement, according to an exemplary embodiment of this disclosure; and

FIG. 4 illustrates an exemplary use of the position sensor arrangement 100, according to an exemplary embodiment of the present disclosure.

### DETAILED DESCRIPTION

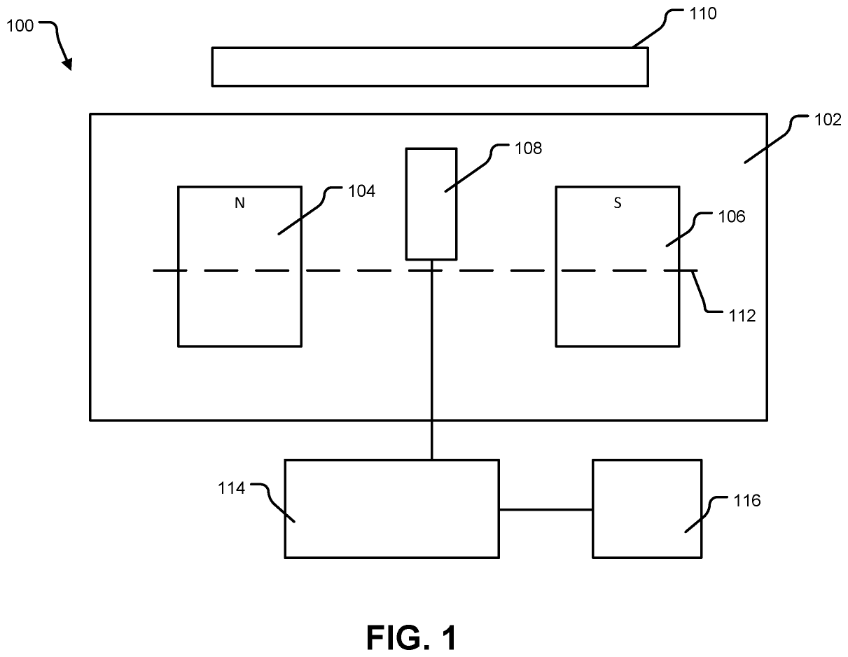

FIG. 1 illustrates a position sensor arrangement 100, according to an exemplary embodiment of this disclosure. The position sensor arrangement 100 includes a housing 102. First and second magnets 104 and 106 may be disposed in the housing 102. Furthermore, a magnetic field sensor 108 is disposed within the housing 102. The magnetic field sensor 108 is a positioned between the first magnet 104 and the second magnet 106. The magnetic field sensor 108 may be a magnet effect sensor, such as a Hall-effect sensor, anisotropic magneto-resistive sensor, giant magnetoresistance sensor, or tunnel magnetoresistance sensor.

The position sensor arrangement 100 further includes a sensor element 110. The sensor element 110 may be positioned, as illustrated, in a vicinity of the housing 102. In the example illustrated in FIG. 1, the magnetic north pole associated with the first magnet 104 is oriented upward, or adjacent to the sensor element 110. Similarly, in the example illustrated in FIG. 1, the magnetic south pole associated with the second magnet 106 is oriented upward, or adjacent to the sensor element 110. However, the orientation of the magnetic poles illustrated in FIG. 1 is purely exemplary. That is, the magnetic pole orientation illustrated in FIG. 1 may be reversed.

As will be described in greater detail in the following, the sensor element 110 may be movable relative to the housing 102. In particular, the sensor element 110 may be coupled to a movable element, such as a movable seat rail associated with a vehicular seat. In an alternative embodiment, the sensor element 110 is fixed and the housing 102 is movable relative to the sensor element 110. For example, in such an alternative embodiment, the housing 100 to may be coupled to a movable element, such as a movable seat rail associated with a vehicular seat. In various embodiments, the housing 102 is coupled to a fixed rail, such as a fixed seat rail attached to a vehicle.

In one embodiment, the sensor element 110 is made of a ferromagnetic material. The ferromagnetic material may include at least one of iron, nickel, or cobalt. Furthermore, the sensor element 110 may be a switching plate that has a substantially rectangular shape. The sensor element 110 may have a width that is at least as great as a distance between the first magnet 104 and the second magnet 106. In another embodiment, the sensor element 110 has a width that is greater than a distance between the first magnet 104 and the second magnet 106.

In an embodiment, the magnetic field sensor 108 may be offset from a centerline 112 associated with the first magnet 104 and/or the second magnet 106. Furthermore, the magnetic field sensor 108 may be coupled to an input of a processing system 114, such as a computing device including a processor and storage, such storage including computer instructions to cause a processor to function, for example, as a position sensing and airbag deployment apparatus. The processing system 114 may receive position related information from the position sensor arrangement 100. Such position related information may be provided by the magnetic field sensor 108. The processing system 114 may be coupled to one or more airbags 116. The processing system 114 may use the position related information to control the deployment of the one or more airbags 116.

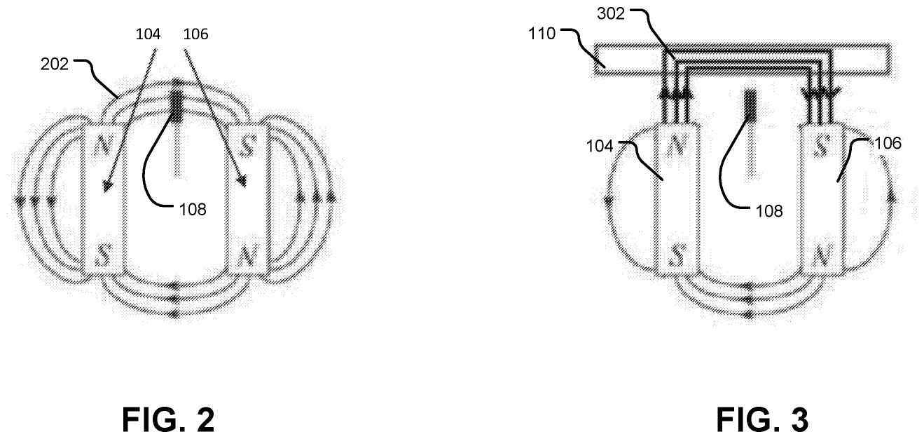

FIG. 2 illustrates magnetic field lines 202 related to the magnets 104 and 106 of the position sensor arrangement 100, according to an exemplary embodiment of this disclosure. As expected, the magnetic field lines 202 direct away from the north poles and toward the south poles. As is illustrated, the magnetic field lines 202 intersect with the magnetic field sensor 108, particularly because the movable sensor element 110 is not in close vicinity of the magnets 104 and 106.

FIG. 3 provides another illustration of magnetic field lines 302 related to the magnets 104 and 106 of the position sensor arrangement 100, according to an exemplary embodiment of this disclosure. As expected, the magnetic field lines 302 direct away from the north poles and toward the south poles. However, the magnetic field lines 302 to do not intersect with the magnetic field sensor 108, as the sensor element 110 is in close proximity to the magnets 104 and 106. Rather, the magnetic field lines 302 concentrate through the sensor element 110, and bypass the magnetic field sensor 108. In the configuration illustrated in FIG. 3, the magnetic field sensor 108 detects zero or nearly zero magnetic field associated with the magnets 104 and 106. Furthermore, as those skilled in the art will appreciate, the magnetic field sensor 108 may detect a magnetic field, associated with the magnets 104 and 106, of increasing strength as the sensor element 110 moves away from the magnets 104 and 106. Moreover, as those skilled in the art will appreciate, the magnetic field sensor 108 may detect a magnetic field, associated with the magnets 104 and 106, of decreasing strength as the sensor element 110 moves toward the magnets 104 and 106.

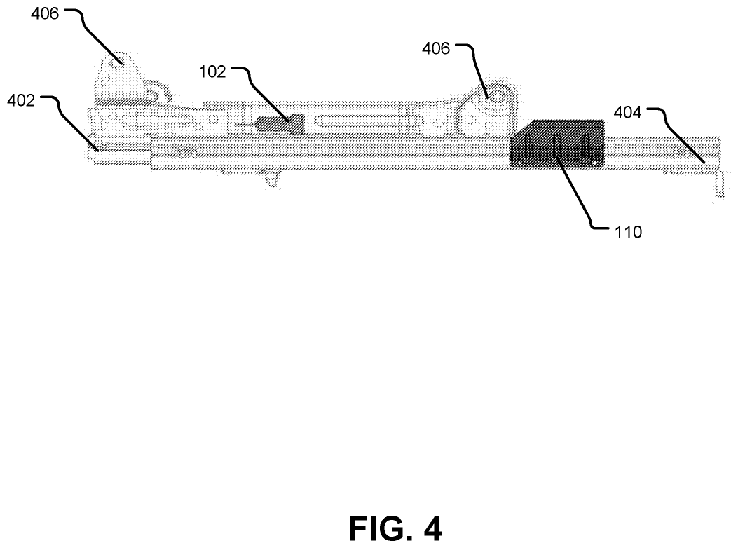

FIG. 4 illustrates an exemplary use of the position sensor arrangement 100, according to an exemplary embodiment of the present disclosure. As is illustrated, the housing 102 is coupled to a movable rail 402. The movable rail 402 may be coupled to a vehicular seat by way of couplers 406. The sensor element 110, shown as a switching plate, may be coupled to a fixed rail 404. In an alternative embodiment, the housing 102 is coupled to the fixed rail 404, and the sensor element 110 is coupled to the movable rail 402. The fixed rail 404 may be coupled and fixed to a vehicle chassis.

In the configuration illustrated in FIG. 4, magnetic field associated with the magnets 104 and 106 included within the housing 102 activate the magnetic field sensor 108. However, as the sensor housing 102 moves closer to the sensor element 110 via the movable rail 402, the magnetic field detected by the magnetic field sensor 108 decreases. Depending on the position of the sensor housing 102 relative to the sensor element 110, the magnetic field detected by the magnetic field sensor 108 increases. For example, the magnetic field sensor 108 would detect an increasing magnetic field as the magnetic field sensor 108 is moved away from a near proximity to the sensor element 110. As the magnetic field sensor 108 detects an increasing, decreasing and/or static magnetic field associated with the magnets 104 and 106, the magnetic field sensor 108 provides corresponding and at times varying voltage levels to the processing system 114. The processing system 114 processes the voltages provided by the magnetic field sensor 108 to ascertain one or more positions associated with the movable rail 402 and therefore an associated vehicular seat that may be coupled to the movable rail 400 to using the couplers 406. Such position data may enable the processing system 114 to deploy the one or more airbags 116 in a predetermined manner.

The advantages of the position sensor arrangement 100 are numerous. For example, the position sensor arrangement 100 is advantageously provided using a reduced parts list compared to conventional position arrangements. The reduced number of parts of the position sensor arrangement 100 allows for the precise and efficient manufacture of the position sensor arrangement 100. Furthermore, advantageously, the failure rate of the position sensor arrangement 100 is very low at least in part because of the reduced number of parts needed to manufacture the position sensor arrangement 100. Moreover, advantageously, the position sensor arrangement 100 does not require the use of shaped magnets, such as curved magnets or other such shaped magnets that are costly to manufacture.

While exemplary position sensors are disclosed, it will be understood by those skilled in the art that various changes may be made and equivalents may be substituted without departing from the spirit and scope of the claims of the application. Other modifications may be made to adapt a particular situation or material to the teachings disclosed above without departing from the scope of the claims. Therefore, the claims should not be construed as being limited to any one of the particular embodiments disclosed, but to any embodiments that fall within the scope of the claims.

We claim:

1. An apparatus, comprising:
a sensor housing;
first and second magnets disposed in the sensor housing;
a magnetic field sensor disposed between the first and second magnets; and
a sensor element positioned in a vicinity of the sensor housing, the sensor element to cause a magnetic field between the first and second magnets to substantially bypass the magnetic field sensor.

2. The apparatus according to claim 1, wherein the sensor element is a switching plate made of ferromagnetic material.

3. The apparatus according to claim 2, wherein the ferromagnetic material is a material including at least one of iron, nickel, or cobalt.

4. The apparatus according to claim 1, wherein the sensor element is a switching plate that has a width at least as great as a distance between the first and second magnets.

5. The apparatus according to claim 4, wherein the width of the switching plate is greater than the distance between the first and second magnets.

6. The apparatus according to claim 1, wherein the sensor housing is disposed on a movable seat rail associated with a vehicular seat and the sensor element is disposed on a fixed seat rail engaged with the movable seat rail.

7. The apparatus according to claim 6, wherein the sensor element is a switching plate made of ferromagnetic material.

8. The apparatus according to claim 7, wherein the ferromagnetic material is a material including at least one of iron, nickel, or cobalt.

9. The apparatus according to claim 1, wherein the magnetic field sensor is a magnet effect sensor.

10. The apparatus according claim 9, wherein the magnet effect sensor is a Hall-effect sensor, Anisotropic Magneto-Resistive sensor, Giant magnetoresistance sensor, or Tunnel magnetoresistance sensor.

11. An apparatus, comprising:
a fixed rail;
a movable rail engaged to the fixed rail, the movable rail movable relative to the fixed rail;
a sensor housing including a plurality of magnets and a magnetic field sensor, the sensor housing coupled to the fixed rail or the movable rail; and
a switching plate coupled to the fixed rail or movable rail that does not include the sensor housing, the switching plate to cause to cause a magnetic field between the first and second magnets to substantially bypass the magnetic field sensor.

12. The apparatus according to claim 11, wherein the movable rail is coupled to a vehicular seat.

13. The apparatus according to claim 11, wherein the switching plate is made of ferromagnetic material.

14. The apparatus according to claim 11, wherein the switching plate is coupled to the fixed rail and the sensor housing is coupled to the movable rail.

15. The apparatus according to claim 11, wherein the switching plate is coupled to the movable rail and in the sensor housing is coupled to the fixed rail.

16. The apparatus according to claim 11, wherein the magnetic field sensor is positioned between the plurality of magnets.

17. The apparatus according to claim 11, wherein the magnetic field sensor is disposed between the plurality of magnets within the sensor housing.

18. The apparatus according to claim 11, wherein the magnetic field sensor is a magnet effect sensor.

19. The apparatus according claim 18, wherein the magnet effect sensor is a Hall-effect sensor, Anisotropic Magneto-Resistive sensor, Giant magnetoresistance sensor, or Tunnel magnetoresistance sensor.
